(19) United States
(12) Patent Application Publication
(10) Pub. No.: US 2009/0123022 A1
(43) Pub. Date: May 14, 2009

(54) Digital cinema projector watermarking system and method

(76) Inventors: Mike Arthur Derrenberger, Hopkinton, MA (US); Chris Sendejas, Simi Valley, CA (US); Mark Leroy Walker, Castaic, CA (US); Chuck Null, Shadow Hills, CA (US)

Correspondence Address: Robert D. Shedd;Thomson Licensing LLC, PO Box 5312, PRINCETON, NJ, 08543-5312, US

(21) Appl. No.: 11/990,680

(22) PCT Filed: Mar. 6, 2006
(86) PCT No.: PCT/US2006/007907

§ 371 Date: Feb. 19, 2008

Related U.S. Application Data
(60) Provisional application No. 60/715,350, filed on Sep. 8, 2005.

(51) Int. Cl. G06K 9/00

(52) U.S. Cl. 382/100

(57) ABSTRACT

A system and method for watermarking a projected image from a digital cinema projector includes a projector having a plurality of watermark image files associated therewith. A scripting mechanism is configured to determine when and where the watermark image files are displayed during the presentation. The watermark image files include a combination of null and non-null watermark images unique to a given projector and rendered in accordance with the scripting mechanism during a rendering of a digital presentation such that the watermark images and their temporal placement identifies the projector rendering the presentation.

### CROSS-REFERENCE TO RELATED APPLICATIONS

This application is related to U.S. Provisional Patent Application Ser. No. 60/715,350, entitled “DIGITAL CINEMA PER PROJECTOR WATERMARKING SCHEME”, filed Sep. 8, 2005, which is incorporated by reference herein in its entirety.

### FIELD OF THE INVENTION

The present invention generally relates to watermarking systems and methods and, more particularly, to watermarking a film in accordance with a unique display device or projector identity.

### BACKGROUND OF THE INVENTION

Current Digital Cinema projectors have limited capabilities for displaying unique watermarks for each projector. The current techniques utilize unique subtitle files created for each projector for each distribution. This method is preparation intensive and is not considered scalable for large numbers of screens.

To date, schemes have been proposed to use spatial intra-frame encoded watermarks to identify a source projector. This approach is easily defeated by pirate editing, however.

Temporal marking schemes for film printing include a separate process, which uses several locations to convey data and one for a parity check. The film is marked in a number of locations. Each location is further divided into zones. Each zone is 8 frames in duration, 3 of which are used for rendering a mark.

One of the possibilities is encoded by virtue of placing a mark in the corresponding zone for a given location. With several zones dedicated to data unique combinations of marks are available. However, the number of combinations is only sufficient for film-print marking.

Unique marks are created for each film through a prescreening process. Marks are created in preparation prior to distribution. Several aspects of film-print based watermarking do not directly translate to digital cinema. For example, the film-based scheme only provides for approximately 74,000 unique combinations. This falls short of the 128,000 minimum requirements for digital cinema. It would be very difficult to uniquely mark each digital “print” in the same manner as film.

Therefore, a need exists to take advantage of the new digital cinema technology to provide in-situ watermarking during projection.

### SUMMARY OF THE INVENTION

The present invention addresses the above concerns. The invention provides for a system for watermarking an image, comprising: a display management system having a plurality of watermark image files associated therewith, and means for generating signals representative of a presentation of images; a scripting mechanism, coupled to the display management system, and configured to determine when and where the watermark image files are displayed during the presentation of images; the watermark image files including watermark images unique to the means for generating signals and being rendered in accordance with the scripting mechanism during the presentation of images such that placement of the watermark images identified the means for generating signals rendering the presentation. In an exemplary embodiment, the system comprises a digital cinema system having a display management system coupled to a projector, wherein a scripting file is transmitted to the digital cinema system with the presentation file. The watermark file is unique to the projector and the presence of the watermarks in accordance with the scripting mechanism may be used to identify the projector rendering the presentation.

The invention also provides a method for rendering a presentation, comprising: receiving a watermark file uniquely associated with a digital image presentation device; receiving a presentation file representative of a presentation of images; receiving scripting instructions associated with the presentation file; and generating image signal representative of the presentation of images having the watermark file included therein in accordance with the scripting instructions, whereby the placement of the watermark file in the presentation identifies the digital image presentation device rendering the presentation. In an exemplary embodiment the presentation is rendered with a digital cinema system and the digital image presentation device comprises a projector. The watermark file is uniquely associated with the projector, and may be assigned to the projector at time of manufacture. The presence of the watermarks in accordance with the scripting mechanism may be used to identify the projector rendering the presentation.

### BRIEF DESCRIPTION OF THE DRAWINGS

The advantages, nature, and various additional features of the present invention will appear more fully upon consideration of the illustrative embodiments now to be described in detail in connection with accompanying drawings wherein:

FIG. 1 is block diagram of an exemplary digital cinema system for creating watermark coding in presentation images in accordance with one embodiment;

FIG. 2 is a diagram showing a piece of film recorded from a digital presentation showing a location and zone for watermark placement;

FIG. 3 is a block/flow diagram showing an illustrative method for rendering unique watermarks in accordance with aspects of the present invention; and

FIG. 4 is a block/flow diagram showing an illustrative method for forensically determining a unique origin of a film based on the watermark coding in accordance with aspects of the present invention.

It should be understood that the drawings are for purposes of illustrating the concepts of the invention and are not necessarily the only possible configuration for illustrating the invention.

### DETAILED DESCRIPTION OF THE INVENTION

In accordance with embodiments described herein, a system and method to emulate unique temporal coding of watermarks even though a common scripting control file is used for playback is illustratively described. Embodiments described herein limit the amount of spatial information needed to constitute a watermark. The requirements which are addressed by watermarking in accordance with aspects of the present invention include, among other things, the following advantages. The scheme permits for the creation of a single subtitle file per distribution, which will support multiple screens with a unique watermark result for each screen. The scheme supports a minimum of 128,000 unique combinations, many more are possible, which permits scalability, and permits deployment for use in as many digital cinema auditoriums as possible.

A same scripting language file controls video playback for each digital cinema projector (for each individual movie). This scripting language file can specify when (frame/time code) a specific watermark will be presented, where (x, y) a specific watermark will be presented, and the names of the files that include the watermark designs.

The same watermark file names can be used for each projector; however, the contents of these files may be different to achieve an emulated temporal watermarking scheme. The watermarks may be “null” (meaning no mark) or “mark” e.g., a dot, which would put a single dot watermark as specified by the scripting language. The watermark files are preferably preloaded before any movie playback. “Null” files will not use much memory space as they do not include an actual watermark.

When the movie and the companion scripting language control file are downloaded to each digital cinema projector, the scripting language controls the movie playback and “when and where” the watermark is placed. While the scripting language calls out when a given watermark file is displayed, the differences in the contents of specific watermark files cause a different sequence of watermarks to be displayed for each projector. This permits a unique watermark to be created for each projector. Further, this watermark is temporal, which means that the presence of the watermark on a specific frame constitutes the watermark (not any information encoded within the mark).

Through careful management of the set of watermark files, a single download to each projector in advance of movie playback may create a unique per projector watermark. Another outcome of this approach is that the watermark placement can be controlled on a per movie basis. That is, the movie can be pre-screened for appropriate locations that balance forensic recovery with reducing audience irritation at the visible watermark. Note that the watermark does not have to be re-downloaded to achieve this. The scripting language permits positioning of individual watermarks based on frame/time code location.

For the specific case of digital cinema, the watermarks may be specified through graphics files (e.g., .png format). In these files, the marks can have different color, luminance and spatial information. So color, luminance and spatial information may be employed to augment information included in the temporal coding scheme.

In digital cinema, physically marking a film is no longer an option, and aspects of the film-print based scheme do not directly translate to digital cinema. The film-based scheme only provides for approximately 74,000 unique combinations. This falls short of the 128,000 minimum requirement dictated by digital cinema standards. Uniquely marking each digital “print” is not possible in the same manner as physical film marking. In accordance with one embodiment, images may be preloaded into a projector and only timing and spatial positioning of the entire watermark can be modified for a presentation while the watermark itself cannot be modified. In the film-print method the mark (glyph) is essentially customized for each print.

It is to be understood that the present invention is described in terms of a digital projector system; however, the present invention is much broader and may include any digital multimedia system, which is capable of digital delivery over a network. In addition, the present invention is applicable to any replay method including, e.g., data delivered or played back by telephone, set top boxes, computer, satellite links, etc. The present invention will now be illustratively described in terms of a digital cinema projector system.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

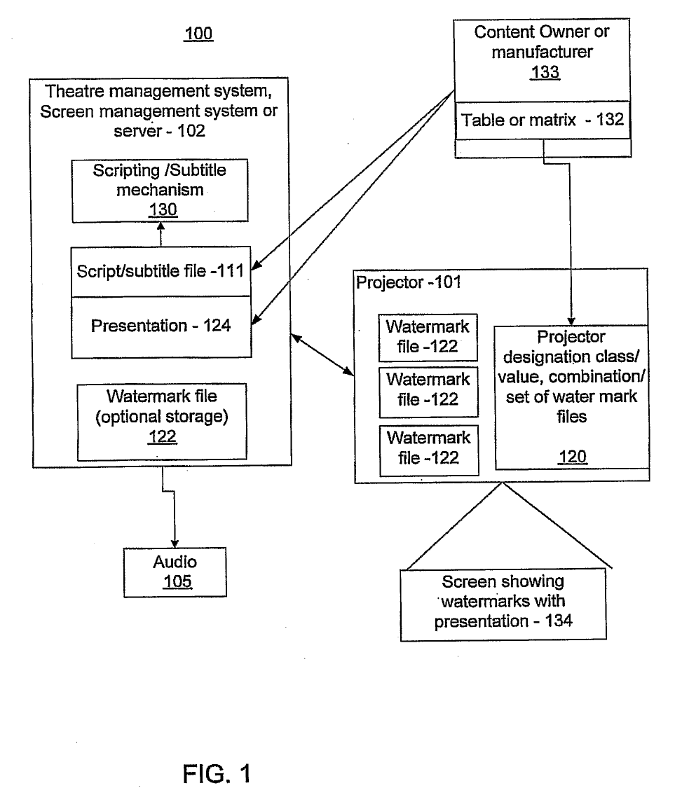

Referring now in specific detail to the drawings in which like reference numerals identify similar or identical elements throughout the several views, and initially to FIG. 1, an illustrative digital cinema system 100 includes a computer or equivalent digital rendering display management system 102, such as e.g., a digital cinema server, theater management system and/or screen management system. Movie distribution and exhibition is currently in transition from using film as the distribution and exhibition medium to using digital media that are distributed as computer files and exhibited using digital cinema playout servers of display management system 102, digital projector(s) 101 and audio processors 105. Digital cinema server 102 is configured to render a presentation 124. The below describes the elements in context of a digital cinema system, however, it is to be understood that the display management system, or system having such display management capability, may be embodied in the form of a processor and associated elements for generating a display signal. Such a processor and associated elements may be included in, for example, but not limited to, a digital set top box, a television receiver, DVD player, and PVR.

Projector 101 includes a factory assigned watermark designation/class or set of watermark files with a combination of null and non-null files 120. The designation of files 120 permits that particular projector 101 to display a particular watermark file or files 122 as provided (e.g., downloaded) to server 102 or projector 101. A plurality of watermark files 122 is provided to each projector by a content owner, distributor, or the like 133. Images of watermarks are generated in accordance with the files 122. A selection of which watermarks will be displayed is determined in accordance with a set of watermarks received with the factory set designation 120 of projector 101. The watermark files 122 (e.g., PNG image files) are pre-deployed to each projector and are preferably not included with the presentation 124. A matrix or table 132 may be employed by content owner 133 to determine how to program each projector.

A script/subtitling file 111 is deployed with the presentation 124 (and received from content owner or other source). While the content of watermarks (images) are stored on projector, the order of displaying these images and the temporal or spatial positioning of these images is controlled by a scripting/subtitling mechanism 130 using the subtitling file 111.

A per-projector watermarking method provides unique visible watermarking per digital projector despite having a common playback scripting mechanism 130. The scripting mechanism 130 controls the digital cinema playback of the video and other ancillary data (such as subtitle information). By exploiting the graphics capability of the scripting/subtitling mechanism 130, watermarks can be placed over the video during the projection process.

To achieve unique watermarking per projector, a special “sequence” of watermark files 122 is used to emulate a temporal watermarking scheme. Further, for simple watermarking symbols, the watermark can be deftly placed in a frame to reduce annoyance of visible watermarking to the viewers of the presentation. The scripting/subtitling mechanism 130 reads the instructions within the script/subtitle file 111. The script/subtitle file 111 is what determines the time (e.g., frame/timecode), and where (e.g., x, y coordinates) to display subtitles or image (watermark) files 122.

In accordance with the present embodiments, the watermarking file names are common for all projectors (101) for a given presentation (124). Temporal modulation of the watermark is achieved through the use of null and non-null images, which are stored with the common names of the watermark files 122. Null images result in no mark rendered to the screen while the non-null images result in a rendered watermark. This may be implemented by the scripting mechanism 130 in conjunction with the script/subtitle file 111 using the watermark files 122 on projector 101 to determine what, when and where watermarks are to be generated and depicted on a projection screen. The content of the matrix 132 is not known by the subtitle mechanism 130, so the subtitle mechanism 130 renders the watermark files 122 in the order programmed in the subtitle file 111 (as sent with the presentation 124). The content of matrix 132 and the subtitle file 111 are known to the content owner 133. While the subtitle file 111 includes assignments for rendering the watermark files 122, the projector 101 expresses the unique allocation of null and non-null images for that projector 101. The subtitling system 130 follows the instructions provided in the subtitle file 111, which drives all projectors identically, but by virtue of the unique contents of the watermark files 122 creates a unique watermark signature for each projector.

Advantageously, a same subtitle file 111 or mechanism 130 controls the video playback for each digital cinema projector 101 (for each individual movie). This scripting language file 111 can specify when (frame/time code) a specific watermark will be presented, where (x, y) a specific watermark will be presented, and the names of the files that include the watermarks. Note that the same watermark file names are used for each projector; however, the contents of these files do not have to be the same. In fact, to achieve an emulated temporal watermarking scheme, the contents of the files are preferably different. In one embodiment, the content of the watermarks may be preloaded on projector 101 or on server 102 and loaded when the appropriate watermark file name is called for from the subtitling mechanism 130.

Table 1 shows a sample of watermark files (WM) 122. To simplify the explanation, it is assumed that the watermarks are either “null” (meaning no mark) or “dot” (non-null) which would put a single dot watermark as specified by the subtitling mechanism language in file 111. The watermark files 122 are preloaded before any movie playback. “Null” files will not use much memory space as they do not include an actual watermark (empty files).

TABLE 1

| | WM1 | WM2 | WM3 | WM4 | . . . | WMN |
|---|---|---|---|---|---|---|
| Projector 1 | null | dot | null | null | | null |
| Projector 2 | dot | dot | null | null | | null |
| Projector 3 | null | null | null | dot | | null |
| . . . | | | | | | |
| Projector n | null | null | null | dot | | dot |

When the movie and the companion scripting language control subtitle file 111 are downloaded to each digital cinema projector 101, the subtitling language mechanism 130 controls the movie playback and “when and where” a watermark is placed. Table 2 shows a hypothetical playback of each projector for a common subtitle control file 111. The subtitle file 111 is the script that controls the playback.

TABLE 2

| | Frame 1 | Frame 2 + WM1 | Frame 3 + WM2 | Frame 4 | Frame 5 + WM3 | Frame 6 + WM4 | . . . | Frame n + WM N |
|---|---|---|---|---|---|---|---|---|
| Projector 1 | Frame 1 | Frame 2 | Frame 3 + dot | Frame 4 | Frame 5 | Frame 6 | | Frame n |
| Projector 2 | Frame 1 | Frame 2 + dot | Frame 3 + dot | Frame 4 | Frame 5 | Frame 6 | | Frame n |
| Projector 3 | Frame 1 | Frame 2 | Frame 3 | Frame 4 | Frame 5 | Frame 6 + dot | | Frame n |
| . . . | | | | | | | | |
| Projector n | Frame 1 | Frame 2 | Frame 3 | Frame 4 | Frame 5 | Frame 6 + dot | | Frame n + dot |

While the subtitle file 111 calls out when a given watermark file 122 is displayed, the differences in the contents of specific watermark files 122 cause a different sequence of watermarks to be displayed for each projector 101. This permits a unique watermark coding to be created for each projector 101. Further, this watermark is temporal. That is, the presence of the watermark on a specific frame constitutes the watermark (not any information encoded within the mark).

As indicated in Table 2, e.g., when projector 2 displays frame 2, a non-null watermark (dot) is also displayed. Through management of a set of watermark files 122, a single download to each projector 101 in advance of movie playback creates a unique per projector watermark. Another outcome of this approach is that the watermark placement can be controlled on a per movie basis. That is, the movie can be pre-screened for appropriate locations that balance forensic recovery with reducing audience irritation at the visible watermark. Note that the watermark files 122 do not have to be re-downloaded to achieve this. The scripting language of subtitling mechanism 130 may position individual watermarks based on frame/time code location.

For digital cinema, the watermark files 122 may include graphics files (e.g., .png format). In these files, the marks can have different colors, luminance and spatial information. It is also possible to use color, luminance and spatial information to augment information included in the temporal coding scheme to add additional dimensions to the coding.

While the watermark files 122 may be similar to subtitling image files, the watermarking files have stricter rendering rules, and the subtitling mechanism may not be appropriate given some of the following constraints. It is not recommended to mix subtitle text with images. The timing of the images will no longer be reliable since the timing is affected by the timing of the text. Images used for watermarking should remain relatively small. Larger images tend to render line-by-line and also affect the timing of the display. Displaying images should be for a minimum of about 36 ticks (one tick is 1/250 seconds) or roughly 3 frames, otherwise the image may not render. It takes at least 3 frames from the end of displaying one image to the beginning of displaying the next. This leads to a minimum image time start-to-start of about 6 frames. 8 frames may be used for historical reasons. These restrictions may not apply in all subtitling mechanisms, but are provided as an illustration of factors to be considered. In a preferred embodiment, a single frame watermark rendering may be employed.

The images of the presentation with watermarks are then displayed on a display screen 134. The display screen 134 shows the content of the presentation with visible but unobtrusive watermarks. In this way, illegal pirating can be traced to a unique projector or other source.

Dot size and intensity (contrast) for watermarks may be determined based on empirical experiments to ensure survivability in typical situations (e.g. camcorder copying). The dots should be perceivable by a viewer to the extent necessary to be present on a recorded version of the presentation but should not intrusive to the viewer. In this way, the watermark can be deciphered in a bootlegged copy of a movie without detracting from the viewing experience of a legitimate viewer.

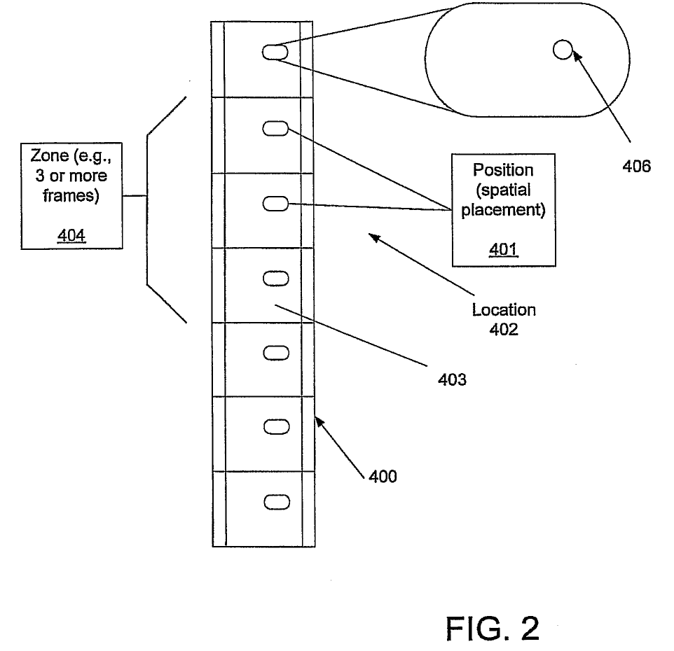

Referring to FIG. 2, in one illustrative embodiment, an encoding scheme uses locations each comprised of zones. FIG. 2 illustratively shows a recorded film 400 so as to indicate the locations and zones in a tangible way. It should be understood that the only film recording that would include these features is one that is recorded from a theater presentation, which is illegal without proper permission. The film 400 illustratively shows a single location 402 and one zone 404 (comprising one or more frames). The location 402 may be determined for a given area or portion of a presentation. A watermark 406 may be placed in a particular position 401 in a frame 403, e.g., positions within a frame or frames 403 of content at location 402 in zone 404.

Each zone 404 is similarly treated as for film-based schemes where a zone 404 is about 8 frames long, of which 3 frames are used to render a watermark. As mentioned, to be visible in an illegal reproduction of the film (e.g., an in-theater video camera recording), each watermark symbol should be present for at least three frames, although fewer frames are acceptable. A location in the context of encoding values is a set of (13) zones and represents a value based on the glyph selected and the zone in which it appears.

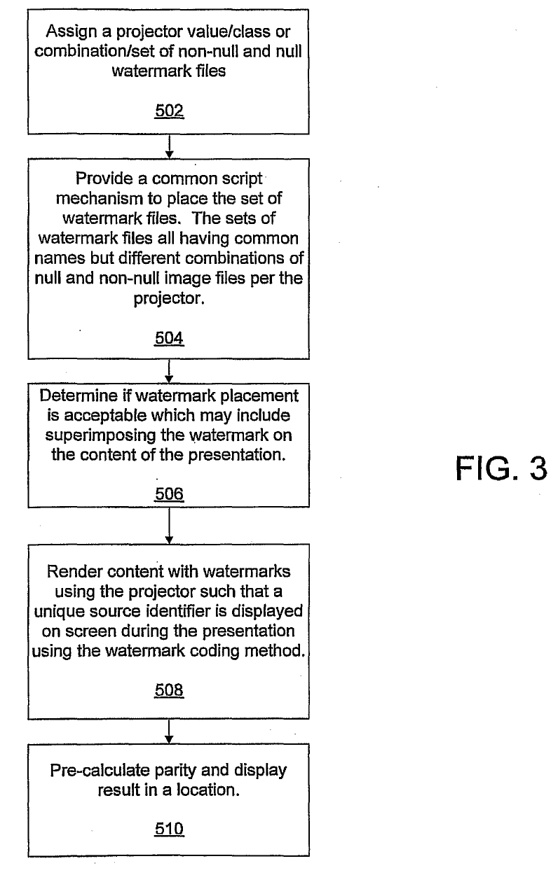

Referring to FIG. 3, a method for applying watermarks during projection to identify the projector or source is illustratively described and shown. In block 502, a digital image projector is assigned a value (e.g., projector1 in Tables 1 and 2) or otherwise set up in accordance with a watermark scheme to permit the selection of watermarks that will be shown and at which locations in a presentation. For example, a predetermined combination of null and non-null watermark files may be provided to the projector. The combination of null and non-null image files is retained by the manufacturer or content owner for forensic value when needed to identify the projector. The value or combination of files (file set) may be assigned by or otherwise provided by, for example, a projection manufacturer or content owner. The set may be input into the system server or may simply be included on the projector. This set or combination of files contributes to the uniqueness of the watermarking during deployment of the presentation.

In block 504, a scripting/subtitling mechanism is employed to determine which watermarks are displayed in accordance with the projector. The scripting/subtitling files are preferably provided with the presentation. The script file includes information for a plurality of image files or watermark files (e.g., WM1 in Table 1) with watermark information. The same script file is sent to all projectors for a given presentation. The correct files to be rendered are selected in accordance with the script/subtitle file using names for files common to all projectors. Whether these files include null or non-null watermark information is dependent on the projector. The unique sets of image files (watermarks) are created and deployed for each projector. The sets include all the same file names for the watermark files, but each set has a different combination of null and non-null watermark files. This “pre-modulates” the temporal and watermark information for each projector. Advantageously, all subsequent presentations may use the same relative timing and watermarks in the zones while the detailed timing and positioning (locations) may be determined by the subtitle/script file, which is sent with the presentation.

In block 506, for watermarking, the content is screened to locate a position in the frames where the watermark will be visible. A placement watermark may be employed as a tool to make sure that all dots or features are viewable. The placement watermark may include a composite of all watermarks associated with a given presentation.

In block 508, during a presentation, in accordance with the projector designation and the image file to be rendered, a unique watermark coding is digitally rendered for a single projector by placing the watermark or watermarks in a predestinated frame or frames. The watermarks may include a sequence of symbols; each symbol may include a dot pattern, for example. The watermarks are preferably run in one or more zones in the presentation, such that a combination of watermark symbol type and temporal placement is unique to an individual projector.

In block 510, a parity calculation may be performed in advance and may be part of the watermarking scheme. In one example, the parity is precalculated and becomes part of the pre-deployed watermark value. For example, in the implementation where 3 locations are assigned values, the 4^{th} (parity) location is calculated based on the sum of the values encoded into the first three locations then a modulo is used after divided by a number, for example, a number of combinations, say 52 in this case. Other parity formulas and values may be employed. The parity value may be displayed in a location other than a location where a watermark is present.

As an example, Table 3 demonstrates four locations each having a series of values. The series of values provide 52 different possibilities for each location. Location D is a modulo 52 of the sum of the values for corresponding zones values for the three locations A, B and C. Other parity formulas and schemes may be employed.

TABLE 3

| Location A | Location B | Location C | Location D |
|---|---|---|---|
| 1 | 1 | 1 | 3 |
| 13 | 13 | 13 | 39 |
| 26 | 26 | 26 | 26 |
| 1 | 13 | 26 | 40 |
| 51 | 51 | 51 | 49 |

The parity provides an additional check. The answer of the parity calculation is displayed on screen at a (e.g., fourth) location, but the other location values need not be displayed, but may correspond to a table or matrix kept by the content owner or other authorized entity.

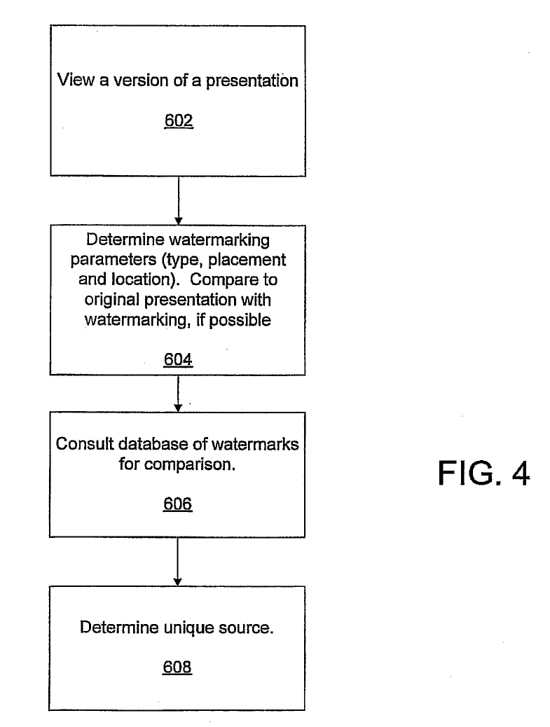

Referring to FIG. 4, a method for employing the watermark to determine a projector from which a presentation was rendered is illustratively shown. In block 602, a presentation version (e.g., an illegally copied film) is reviewed to determine watermarkings. Detection can be accomplished using multiple techniques.

In block 604, a determination of the watermarking parameters is determined, for example, the temporal locations (frame numbers, etc for a given film) and type of symbol and/or sequence in the zones. For scenarios where mirroring, rotation or skew are injected into the image's registration, a comparison with the original image is recommended to avoid misinterpretation of the watermark. In the case where a mark is obliterated, blurred or frames cut from the footage, some data can still be retrieved based on temporal encoding. This is done by recognizing the specific location in time that has been modified and therefore the specific temporal encoding parameter.

In block 606, a database of projectors is consulted to determine which projector rendered the film. The database will include the watermark types and the combination of watermarks in sequences as well as locations where the watermarks were positioned for a given presentation. In this way, a unique projector will be determined in block 608.

Having described preferred embodiments for system and method for digital cinema projector watermarking system and method (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims.

1. A system for watermarking an image, comprising:
a display management system having a plurality of watermark image files associated therewith, and means for generating signals representative of a presentation of images;
a scripting mechanism, coupled to the display management system, and configured to determine when and where the watermark image files are displayed during the presentation of images;
the watermark image files including watermark images associated with the means for generating signals, and being rendered in accordance with the scripting mechanism during the presentation of images whereby placement of the watermark images according to the scripting mechanism identifies the means for generating signals rendering the presentation.

2. The system as recited in claim 1, wherein the scripting mechanism includes null and non-null image files and renders the non-null image files in accordance with assigned frames of the presentation.

3. The system as recited in claim 1, wherein the scripting mechanism includes a subtitle mechanism configured to render the watermark images.

4. The system as recited in claim 1, wherein the watermark images include PNG files.

5. The system as recited in claim 1, wherein the means for generating signals comprises a projector in a digital cinema system.

6. The system as recited in claim 1, wherein the watermark image files are assigned at manufacture of the projector.

7. The system as recited in claim 1, wherein the scripting mechanism determines a position in the presentation for watermark images based on frame/time code location.

8. The system as recited in claim 1, wherein the means for generating signals is identified based on the watermark images and their temporal placement in the presentation of images.

9. A system for watermarking a projected image from a digital cinema projector, comprising:
a projector configured to render a digital presentation and having associated with the projector a watermark coding which identifies the projector during the rendering of the presentation, the coding being uniquely associated with the projector;
a scripting mechanism configured to render the watermark image files in accordance with the watermark coding, the scripting mechanism being configured to determine when and where the watermark image files are displayed during the presentation;
the watermark coding including watermark images unique to the projector and rendered in accordance with the scripting mechanism during the rendering of the digital presentation such that the watermark images and their temporal placement identifies the projector rendering the presentation.

10. The system as recited in claim 9, wherein the projector includes null and non-null watermark image files and renders the non-null image files in accordance with assigned frames of the presentation.

11. The system as recited in claim 9, wherein the scripting mechanism includes a subtitle mechanism configured to render the watermark image files.

12. The system as recited in claim 9, wherein the watermark image files include PNG files.

13. The system as recited in claim 9, wherein the watermark images include a geometric shape or shapes.

14. The system as recited in claim 9, wherein the watermark coding is assigned at manufacture of the projector.

15. The system as recited in claim 9, wherein the scripting mechanism determines a position in the presentation for watermark images based on frame/time code location.

16. The system as recited in claim 9, wherein the watermark images use color, luminance and spatial information.

17. A method for watermarking a presentation, comprising:
receiving a plurality of watermark files in a projector, including null and non-null watermark files, wherein the null and non-null files are selected for given file names in a particular combination to identify the projector during the rendering of a presentation; and
rendering null and non-null watermark files with a scripting mechanism to place the non-null marks in a temporal relationship with the presentation to uniquely identify the projector.

18. The method as recited in claim 17, wherein the null images include empty files and the rendering includes placing watermarks generated by the non-null image files at selected frame numbers.

19. The method as recited in claim 17, wherein the scripting mechanism is provided with a presentation, and file names for the watermark files are common for all projectors and further comprising generating a plurality of watermark file sets wherein all sets include files with the same names, and selecting which watermark files in the set have null and non-null watermark files.

20. The method as recited in claim 17, wherein rendering includes rendering non-null watermarks using a subtitling mechanism.

21. The method as recited in claim 17, wherein providing includes assigning a set of non-null and null watermark files when the projector is manufactured.

22. A method of operating a digital image presentation device, comprising:
receiving a watermark file associated with the digital image presentation device;
receiving a presentation file representative of a presentation of images;
receiving scripting instructions associated with the presentation file;
generating image signals representative of the presentation of images having the watermark file included therein in accordance with the scripting instructions, whereby the placement of the watermark file in the presentation identifies the digital image presentation device rendering the presentation.

23. The method according to claim 22, wherein the watermark file is included with the presentation using a subtitling mechanism associated with the digital image presentation device.

24. The method according to claim 22, wherein the watermark files include null and non-null files for placing the watermark files in the presentation.

25. A method for providing a presentation of images to a digital processing apparatus, comprising:
associating a scripting file with a presentation file representative of the presentation of images, the scripting file configured to control the digital processing apparatus wherein a watermark file uniquely associated with the digital processing apparatus is included with the presentation in accordance with instructions in the scripting file, whereby placement of the watermark file in the presentation identifies the digital processing apparatus rendering the presentation; and
transmitting the scripting file and the presentation file to the digital processing apparatus.

26. The method according to claim 25, wherein the scripting mechanism determines a position in the presentation for watermark images such that the position and temporal placement of the watermark images identifies the digital processing apparatus.

27. The method according to claim 25, wherein the digital processing apparatus comprises a projector in a digital cinema system.
